(19) United States
(12) Patent Application Publication
(10) Pub. No.: US 2025/0384847 A1
(43) Pub. Date: Dec. 18, 2025

(54) DISPLAY DEVICE AND ELECTRONIC DEVICE INCLUDING THE SAME

(71) Applicant: Samsung Display Co., Ltd., Yongin-si (KR)

(72) Inventor: Moon Sang HWANG, Yongin-si (KR)

(21) Appl. No.: 19/204,123

(22) Filed: May 9, 2025

(30) Foreign Application Priority Data
Jun. 18, 2024 (KR) 10-2024-0078869
Sep. 5, 2024 (KR) 10-2024-0121091

(51) Int. Cl. G09G 3/3275

(52) U.S. Cl. CPC G09G 3/3275; G09G 2320/0209; G09G 2320/0257; G09G 2320/0276; G09G 2320/0285

(57) ABSTRACT

A display device includes a display panel including a plurality of pixel rows including a plurality of pixels; a compensation driver configured to generate an i-th compensation coefficient based on a difference between an (i−1)-th image data provided to an (i−1)-th pixel row among the plurality of pixel rows and an i-th image data provided to an i-th pixel row among the plurality of pixel rows, and configured to generate an i-th compensation data provided to the i-th pixel row by applying the i-th compensation coefficient to the i-th image data; and a data driver configured to generate a data signal based on the i-th compensation data and to supply the data signal to the i-th pixel row, wherein i is a natural number greater than 1.

### CROSS-REFERENCE TO RELATED APPLICATION

The present application claims priority to and the benefit of Korean Patent Application No. 10-2024-0078869, filed on Jun. 18, 2024, and Korean Patent Application No. 10-2024-0121091, filed on Sep. 5, 2024, in the Korean Intellectual Property Office, the entire contents of which are incorporated herein by reference.

### BACKGROUND

### 1. Field

Aspects of embodiments of the present disclosure relate to a display device.

### 2. Description of the Related Art

As information technology develops, the importance of display devices, which are a connection medium between users and information, is emerging. Accordingly, the use of display devices such as liquid crystal display devices, organic light emitting display devices, and plasma display devices is increasing.

Each pixel of the display device may emit light with a luminance corresponding to a data voltage supplied through a data line. The display device may display an image frame by a combination of light emission of pixels.

In this case, a line crosstalk effect or a vertical crosstalk effect that degrades display quality depending on the pattern of the image frame may occur. When a line crosstalk effect occurs, an unintended bright line or dark line is displayed, so that the user may recognize it as a display error.

The above information disclosed in this Background section is only for enhancement of understanding of the background of the invention and therefore it may contain information that does not form the prior art.

### SUMMARY

Aspects of some embodiments of the present disclosure are directed to a display device that may apply a compensation coefficient to raw data supplied to a display panel in order to eliminate a vertical crosstalk effect.

According to some embodiments of the present disclosure, there is provided a display device including a display panel including a plurality of pixel rows including a plurality of pixels; a compensation driver configured to generate an i-th compensation coefficient based on a difference between an (i−1)-th image data provided to an (i−1)-th pixel row among the plurality of pixel rows and an i-th image data provided to an i-th pixel row among the plurality of pixel rows, and configured to generate an i-th compensation data provided to the i-th pixel row by applying the i-th compensation coefficient to the i-th image data; and a data driver configured to generate a data signal based on the i-th compensation data and to supply the data signal to the i-th pixel row, wherein i is a natural number greater than 1.

In some embodiments, the compensation driver may include: a data comparator configured to calculate the difference between the (i−1)-th image data and the i-th image data to generate i-th change data; a data converter configured to convert the i-th change data corresponding to grayscale change into an i-th voltage change amount; and a calculator configured to generate the i-th compensation coefficient based on the i-th voltage change amount and an accumulated voltage change amount, and the accumulated voltage change amount may be a value obtained by accumulating and adding the voltage change amount received from the data converter.

In some embodiments, the display panel may include x pixel rows, and the accumulated voltage change amount may be a sum of x voltage change amounts, and wherein x is a natural number greater than 1.

In some embodiments, the accumulated voltage change amount may be a value obtained by accumulating and adding an i-th voltage change amount of a previous frame to an (i−1)-th voltage change amount of a current frame.

In some embodiments, the calculator may be configured to generate the i-th compensation coefficient by subtracting the i-th voltage change amount from the accumulated voltage change amount.

In some embodiments, the i-th compensation coefficient may include compensation coefficients applied to respective pixels of the i-th pixel row, and the accumulated voltage change amount may be a sum of accumulated voltage change amounts of respective pixels of the i-th pixel row.

In some embodiments, the i-th compensation coefficient may be a sum of x−1 voltage changes.

In some embodiments, the i-th compensation coefficient may be a value obtained by accumulating and adding an (i+1)-th voltage change amount of a previous frame to an (i−1)-th voltage change amount of a current frame.

In some embodiments, the calculator may be configured to generate the i-th compensation coefficient and to update the accumulated voltage change amount to a value obtained by adding the i-th voltage change amount to the i-th compensation coefficient.

In some embodiments, the updated accumulated voltage change amount may be a value obtained by accumulating and adding an (i+1)-th voltage change amount of a previous frame to an i-th voltage change amount of a current frame.

In some embodiments, the compensation driver may further include: a first memory storing the (i−1)-th image data; and a second memory storing the i-th compensation coefficient.

In some embodiments, the compensation driver may further include a first look-up table (LUT) configured to store voltage values corresponding to grayscales, and the data converter may be configured to convert the i-th change data into an i-th voltage change amount based on the first look-up table.

In some embodiments, the compensation driver may further include an image update detector configured to compare the current frame and the previous frame, and to output a reset signal to the calculator and the second memory in response to the current frame and the previous frame being different, and the reset signal may initialize the accumulated voltage change amount stored in the calculator and the i-th compensation coefficient stored in the second memory.

In some embodiments, the image update detector may be configured not to output a reset signal to the calculator and the second memory in response to the current frame and the previous frame being the same.

In some embodiments, the compensation driver may further include a second look-up table configured to store a weight according to a temperature of the display device, a position of the i-th pixel row, and a frequency of the display panel, and the compensation driver may be configured to generate the i-th compensation data by applying the weight and the i-th compensation coefficient.

According to some embodiments of the present disclosure, there is provided a driving method of a display device, including: receiving current row data applied to a current pixel row including a plurality of pixels; generating a voltage change amount based on a difference between a previous row data and the current row data; generating a compensation coefficient corresponding to the current pixel row by subtracting the voltage change amount from an accumulated voltage change amount; and generating compensation row data applied to the current pixel row by applying the compensation coefficient to the current row data.

In some embodiments, the generating of the voltage change amount based on the difference between the previous row data and the current row data may include: generating change data by calculating a grayscale change of the previous row data and the current row data; and converting the change data in a grayscale domain into the voltage change amount in a voltage domain.

In some embodiments, the driving method of the display device may further include: updating the accumulated voltage change amount to a value obtained by adding the voltage change amount to the compensation coefficient, after generating the compensation coefficient.

In some embodiments, the accumulated voltage change amount may be a value that is accumulated and added from a current voltage change amount of a previous frame to a previous voltage change amount of a current frame.

In some embodiments, the current voltage change amount of the previous frame may be a value obtained by converting a grayscale change of data applied to the current pixel row in the previous frame and data applied to a previous pixel row in the previous frame into a voltage domain, and the previous voltage change amount of the current frame may be a value obtained by converting a grayscale change of data applied to the previous pixel row in the current frame and data applied to the previous pixel row in the previous frame into a voltage domain.

According to some embodiments of the present disclosure, there is provided an electronic device including: an input/output device configured to receive input data and provide output data; a processor connected to the input/output device and configured to perform computations based on the input data; and a display device configured to receive input data from the processor, the display device including: a display panel including a plurality of pixel rows including a plurality of pixels; a compensation driver configured to generate an i-th compensation coefficient based on a difference between an (i−1)-th image data provided to an (i−1)-th pixel row among the plurality of pixel rows and an i-th image data provided to an i-th pixel row among the plurality of pixel rows, and configured to generate an i-th compensation data provided to the i-th pixel row by applying the i-th compensation coefficient to the i-th image data; and a data driver configured to generate a data signal based on the i-th compensation data and to supply the data signal to the i-th pixel row, wherein i is a natural number greater than 1.

In some embodiments, the electronic device is a smartphone.

The display device according to the embodiment of the present disclosure may prevent or substantially reduce vertical crosstalk or line crosstalk that may occur between adjacent pixel columns.

### BRIEF DESCRIPTION OF THE DRAWINGS

FIG. 1 illustrates a block diagram of a display device according to an embodiment.

FIG. 2 illustrates a block diagram of one of sub-pixels of FIG. 1 according to some embodiments of the present disclosure.

FIG. 3 illustrates a circuit diagram of the sub-pixel of FIG. 2 according to some embodiments of the present disclosure.

FIG. 4 illustrates a block diagram of a compensation driver according to some embodiments of the present disclosure.

FIG. 5 illustrates a block diagram of a compensation coefficient generation unit according to some embodiments of the present disclosure.

FIG. 6 illustrates a block diagram of a compensation coefficient generation unit according to some embodiments of the present disclosure.

FIG. 7 is a drawing for explaining an operation of generating an accumulated voltage change amount and a compensation coefficient of a calculator according to some embodiments of the present disclosure.

FIG. 8 illustrates a block diagram of a compensation unit according to some embodiments of the present disclosure.

FIG. 9 illustrates a flowchart of an operation of the compensation driver of FIG. 1 according to some embodiments of the present disclosure.

FIG. 10 is a drawing for explaining luminance of a display panel before crosstalk is compensated according to some embodiments of the present disclosure.

FIG. 11 is a drawing for explaining luminance of a display panel after crosstalk is compensated according to some embodiments of the present disclosure.

FIG. 12 illustrates a block diagram of an electronic device according to some embodiments of the present disclosure.

FIG. 13 illustrates an example in which the electronic device of FIG. 12 is implemented as a smart phone according to some embodiments of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

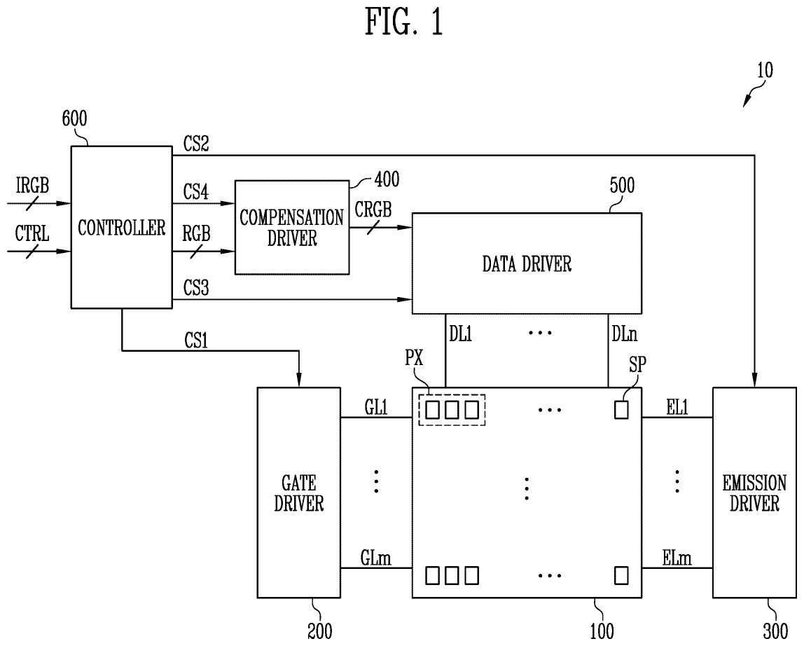

FIG. 1 illustrates a block diagram of a display device according to some embodiments of the present disclosure.

Referring to FIG. 1, a display device 10 may include a display panel 100, a gate driver 200, an emission driver 300, a compensation driver 400, a data driver 500, and a controller 600.

The display panel 100 includes sub-pixels SP. The sub-pixels SP may be connected to the gate driver 200 through first to m-th gate lines GL1 to GLm (where “m” is a natural number). The sub-pixels SP may be connected to the data driver 500 through first to n-th data lines DL1 to DLn (where “n” is a natural number).

Each of the sub-pixels SP may include at least one light emitting element configured to generate light. Accordingly, the sub-pixels SP may respectively generate light of a specific color, such as red, green, blue, cyan, magenta, yellow, or the like. Two or more of the sub-pixels SP may comprise one pixel PX. For example, as shown in FIG. 1, three sub-pixels SP may comprise one pixel PX.

The gate driver 200 may be connected to the sub-pixels SP arranged in a row direction through the first to m-th gate lines GL1 to GLm. The gate driver 200 may output gate signals to the first to m-th gate lines GL1 to GLm in response to a first control signal CS1.

The gate driver 200 may sequentially supply gate signals to the first to m-th gate lines GL1 to GLm. When the gate signals are sequentially supplied to the first to m-th gate lines GL1 to GLm, the sub-pixels SP may be selected in horizontal line units (for example, pixel rows).

In some embodiments, the first control signal CS1 may include a start signal indicating the start of each frame, a horizontal synchronization signal for outputting gate signals in synchronization with the timing at which data signals are applied, and the like.

The emission driver 300 may be connected to the sub-pixels SP arranged in the row direction through the first to m-th emission control lines EL1 to ELm. The emission driver 300 may output emission control signals to the first to m-th emission control lines EL1 to ELm in response to the second control signal CS2.

The gate driver 200 and the emission driver 300 may be disposed on one side of the display panel 100. However, embodiments are not limited thereto. For example, each of the gate driver 200 and the emission driver 300 may be divided into two or more physically and/or logically separated drivers, and the drivers may be disposed on one side of the display panel 100 and another side of the display panel 100 opposite to the one side. As described above, the gate driver 200 and the emission driver 300 may be disposed around the display panel 100 in various forms according to the embodiments.

The compensation driver 400 may generate compensation data CRGB by applying a compensation coefficient to image data RGB received from the controller 600. The image data RGB may be raw data that is not compensated. The compensation data CRGB may be data that compensates for vertical crosstalk of raw data. For example, the compensation data CRGB may have a compensation grayscale generated by applying a compensation coefficient to the grayscale of the image data RGB.

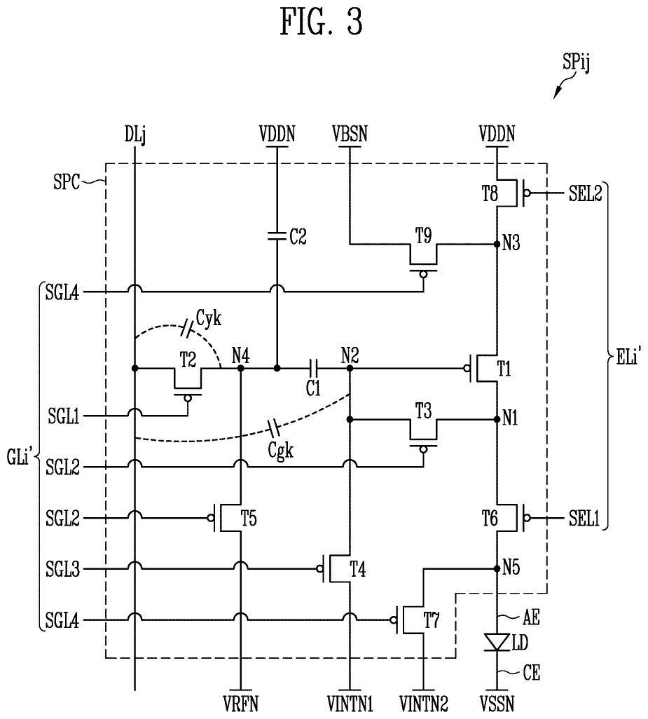

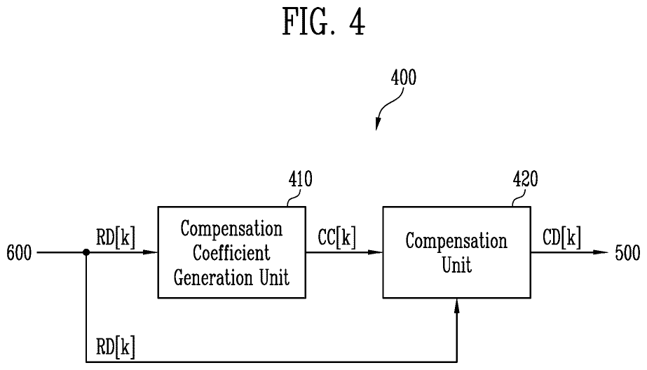

A more detailed description of the vertical crosstalk will be described later with reference to FIG. 3. In addition, a detailed operation of the compensation driver 400 will be described with reference to FIG. 4 to FIG. 8.

The compensation driver 400 may receive a fourth control signal CS4 from the controller 600. The compensation driver 400 operates in response to the fourth control signal CS4. The fourth control signal CS4 may control an operation of the compensation driver 400.

The data driver 500 may be connected to the sub-pixels SP arranged in a column direction through the first to n-th data lines DL1 to DLn. The data driver 500 may receive the compensation data CRGB from the compensation driver 400 and may receive the third control signal CS3 from the controller 600.

In FIG. 1, the compensation driver 400 is shown as a separate configuration from the controller 600, but the present disclosure is not limited thereto, and in some embodiments, the compensation driver 400 may be configured to be integrated into the controller 600.

The data driver 500 may operate in response to the third control signal CS3. In some embodiments, the third control signal CS3 may include a source start pulse, a source shift clock, a source output enable signal, and the like.

The data driver 500 may apply data signals having grayscale voltages corresponding to the compensation data CRGB to the first to n-th data lines DL1 to DLn by using voltages from a voltage generator.

A gate signal may be applied to each of the first to m-th gate lines GL1 to GLm so that data signals corresponding to the compensation data CRGB may be applied to the data lines DL1 to DLm to the selected sub-pixels SP. Accordingly, the corresponding sub-pixels SP may generate light corresponding to the data signals. Accordingly, an image may be displayed on the display panel 100.

In some embodiments, the gate driver 200, the emission driver 300, the compensation driver 400, and the data driver 500 may include complementary metal-oxide semiconductor (CMOS) circuit elements.

In some embodiments, the display device 10 may further include a voltage generator. The voltage generator may operate in response to a voltage control signal from controller 600. The voltage generator may be configured to generate a plurality of voltages and may provide the generated voltages to constituent elements of the display device 10. For example, the voltage generator may be configured to generate a plurality of voltages by receiving an input voltage from the outside of the display device 10, adjusting the received voltage, and regulating the adjusted voltage.

For example, the voltage generator may generate a first power voltage and a second power voltage. The first power voltage may have a relatively high voltage level, and the second power voltage may have a voltage level lower than a first power voltage VDD. In some other embodiments, the first power voltage or the second power voltage may be provided by an external device of the display device 10.

In addition, the voltage generator may generate various voltages. For example, the voltage generator may generate an initialization voltage applied to the sub-pixels SP.

The controller 600 may control various operations of the display device 10. The controller 600 may receive input image data IRGB and a control signal CTRL for controlling the display of the input image data, from the outside. The controller 600 may provide first to third control signals CS1 to CS3 in response to the control signal CTRL.

The controller 600 may convert the input image data IRGB to be suitable for the display device 10 or the display panel 100 to output the image data RGB. In some embodiments, the controller 600 may output the image data RGB by aligning the input image data IRGB to be suitable for the sub-pixels SP of a row unit.

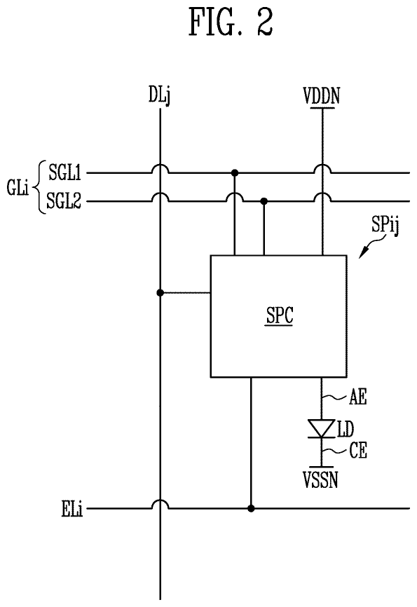

FIG. 2 illustrates a block diagram of one of sub-pixels of FIG. 1 according to some embodiments of the present disclosure. In FIG. 2, among the sub-pixels SP of FIG. 1, a sub-pixel SP ij disposed in an i-th row (i is an integer greater than 1 and less than or equal to m) and a j-th column (j is an integer greater than 1 and less than or equal to n) is illustrated as an example.

Referring to FIG. 2, the sub-pixel SP ij may include a sub-pixel circuit SP C and a light emitting element LD.

The light emitting element LD may be connected between a first power voltage node VDDN and a second power voltage node VSSN. In some embodiments, the first power voltage node VDDN may be a node that transmits the first power voltage, and the second power voltage node VSSN may be a node that transmits the second power voltage.

An anode electrode AE of the light emitting element LD may be connected to the first power voltage node VDDN through the sub-pixel circuit SPC, and a cathode electrode CE of the light emitting element LD may be connected to the second power voltage node VSSN. For example, the anode electrode AE of the light emitting element LD may be connected to the first power voltage node VDDN through one or more transistors included in the sub-pixel circuit SPC.

The sub-pixel circuit SPC may be connected to an i-th gate line GLi among the first to m-th gate lines GL1 to GLm of FIG. 1, an i-th emission control line ELi among the first to m-th emission control lines EL1 to ELm of FIG. 1, and a j-th data line DLj among the first to n-th data lines DL1 to DLn of FIG. 1. The sub-pixel circuit SPC may be configured to control the light emitting element LD according to signals received through these signal lines.

The sub-pixel circuit SPC may operate in response to a gate signal received through the i-th gate line GLi. The i-th gate line GLi may include one or more sub-gate lines. In some embodiments, as shown in FIG. 2, the i-th gate line GLi may include first and second sub-gate lines SGL1 and SGL2. The sub-pixel circuit SPC may operate in response to gate signals received through the first and second sub-gate lines SGL1 and SGL2. As such, when the i-th gate line GLi includes two or more sub-gate lines, the sub-pixel circuit SPC may operate in response to gate signals received through the corresponding sub-gate lines.

The sub-pixel circuit SPC may operate in response to a light emitting control signal received through the i-th emission control line ELi. In some embodiments, the i-th emission control line ELi may include one or more sub-emission control lines. When the i-th emission control line ELi includes two or more sub-emission control lines, the sub-pixel circuit SPC may operate in response to light emitting control signals received through the corresponding sub-emission control lines.

The sub-pixel circuit SPC may receive a data signal through the j-th data line DLj. The sub-pixel circuit SPC may store a voltage corresponding to the data signal in response to at least one of the gate signals received through the first and second sub-gate lines SGL1 and SGL2. In response to the emission control signal received through the i-th emission control line ELi, the sub-pixel circuit SPC may adjust the driving current flowing from the first power voltage node VDDN to the second power voltage node VSSN through the light emitting element LD according to the stored voltage. Accordingly, the light emitting element LD may generate light of luminance corresponding to the data signal.

FIG. 3 illustrates a circuit diagram of the sub-pixel of FIG. 2 according to some embodiments of the present disclosure.

Referring to FIG. 3, the sub-pixel SP ij may include a sub-pixel circuit SP C and a light emitting element LD.

The sub-pixel circuit SPC may be connected to an i-th gate line GLi′, an i-th emission control line ELi′, and a j-th data line DLj. Compared to the i-th gate line GLi of FIG. 2, the i-th gate line GLi′ may further include a third sub-gate line SGL3, a fourth sub-gate line SGL4, and a fifth sub-gate line SGL5. Compared to the i-th emission control line ELi of FIG. 2, the i-th emission control line ELi′ may include a first sub-emission control line SEL1 and a second sub-emission control line SEL2.

The sub-pixel circuit SPC may include first to ninth transistors T1 to T9 and first and second capacitors C1 and C2.

The first transistor T1 may be connected between the first power voltage node VDDN and a first node N1. A gate electrode of the first transistor T1 may be connected to a second node N2, and accordingly, the first transistor T1 may be turned on according to a voltage level of the second node N2. The first transistor T1 may be referred to as a driving transistor.

The second transistor T2 may be connected between the j-th data line DLj and a fourth node N4. A gate electrode of the second transistor T2 may be connected to the first sub-gate line SGL1, and accordingly, the second transistor T2 may be turned on in response to the gate signal of the first sub-gate line SGL1. The second transistor T2 may be referred to as a switching transistor.

The third transistor T3 may be connected between the first node N1 and the second node N2. In addition, a gate electrode of the third transistor T3 may be connected to the second sub-gate line SGL2, and accordingly, the third transistor T3 may be turned on in response to the gate signal of the second sub-gate line SGL2. When the third transistor T3 is turned on, the first transistor T1 may be diode-connected.

The fourth transistor T4 may be connected between the second node N2 and a first initialization voltage node VINTN1. A gate electrode of the fourth transistor T4 may be connected to the third sub-gate line SGL3, and accordingly, the fourth transistor T4 may be turned on in response to the gate signal of the third sub-gate line SGL3. The first initialization voltage node VINTN1 may be a node that transmits the first initialization voltage, and the first initialization voltage may be less than the first power voltage and greater than the second power voltage.

The fifth transistor T5 may be connected between the second node N2 and the reference voltage node VRFN. A gate electrode of the fifth transistor T5 may be connected to the second sub-gate line SGL2, and accordingly, the fifth transistor T5 may be turned on in response to the gate signal of the second sub-gate line SGL2. The reference voltage node VRFN may be a node that transmits a reference voltage, and the reference voltage may be less than the first power voltage and may be greater than the second power voltage. In addition, the initialization voltage may be less than the reference voltage.

The sixth transistor T6 may be connected between the first node N1 and the fifth node N5. The fifth node N5 may be the anode electrode AE of the light emitting element LD. A gate electrode of the sixth transistor T6 may be connected to the first sub-emission control line SEL1, and accordingly, the sixth transistor T6 may be turned on in response to the gate signal of the first sub-emission control line SEL1.

The seventh transistor T7 may be connected between the fifth node N5 and a second initialization voltage node VINTN2. A gate electrode of the seventh transistor T7 may be connected to the fourth sub-gate line SGL4, and accordingly, the seventh transistor T7 may be turned on in response to the gate signal of the fourth sub-gate line SGL4. The second initialization voltage node VINTN2 may be a node that transmits a second initialization voltage, and the second initialization voltage may be less than the first power voltage and may be greater than the second power voltage.

The eighth transistor T8 may be connected between the first power voltage node VDDN and the third node N3. A gate electrode of the eighth transistor T8 may be connected to the second sub-emission control line SEL2, and accordingly, the eighth transistor T8 may be turned on in response to the gate signal of the second sub-emission control line SEL2.

The ninth transistor T9 may be connected between a bias voltage node VBSN and the third node N3. A gate electrode of the ninth transistor T9 may be connected to the fourth sub-gate line SGL4, and accordingly, the ninth transistor T9 may be turned on in response to the gate signal of the fourth sub-gate line SGL4. The bias voltage node VBSN may be a node that transmits a bias voltage, and the bias voltage may be less than the first power voltage and may be greater than the second power voltage.

The first capacitor C1 may be connected between the second node N2 and the fourth node N4. The second capacitor C2 may be connected between the first power voltage node VDDN and the fourth node N4.

As described above, the sub-pixel circuit SPC may include the first to ninth transistors T1 to T9 and the first and second capacitors C1 and C2. However, embodiments are not limited thereto.

The sub-pixel circuit SPC may be implemented as one of various circuits including a plurality of transistors and one or more capacitors. For example, the sub-pixel circuit SPC may include two transistors and one capacitor. Depending on the embodiments of the sub-pixel circuit SPC, the number of sub-gate lines included in the i-th gate line GLi′ may vary.

The first to ninth transistors T1 to T9 may be P-type transistors. Each of the first to ninth transistors T1 to T9 may be a metal oxide silicon field effect transistor (MOSFET) including a body electrode. For example, the turn-off level may be a high voltage level and the turn-on level may be a low voltage level. For example, when a signal applied to the control electrode of the P-type transistor has a low voltage level, the P-type transistor may be turned on. For example, when a signal applied to the control electrode of the P-type transistor has a high voltage level, the P-type transistor may be turned off.

However, embodiments are not limited thereto. For example, at least one of the first to ninth transistors T1 to T9 may be replaced with an N-type transistor. For example, the turn-on level may be a high voltage level, and the turn-off level may be a low voltage level. For example, when a signal applied to the control electrode of the N-type transistor has a low voltage level, the N-type transistor may be turned off. For example, when a signal applied to the control electrode of the N-type transistor has a high voltage level, the N-type transistor may be turned on.

In some embodiments, the first to ninth transistors T1 to T9 may include an amorphous silicon semiconductor, a monocrystalline silicon semiconductor, a polycrystalline silicon semiconductor, and/or an oxide semiconductor.

The light emitting element LD may include the anode electrode AE, the cathode electrode CE, and a light emitting layer. The light emitting layer may be disposed between the anode electrode AE and the cathode electrode CE.

After the data signal transmitted through the j-th data line DLj is reflected in the voltage of the second node N2, the sixth transistor T6 and the eighth transistor T8 may be turned on when the emission control signals of the i-th emission control lines ELi are enabled to the high voltage level. In addition, the first transistor T1 may be turned on according to the voltage of the second node N2, and accordingly, a current may flow from the first power voltage node VDDN to the second power voltage node VSSN. The light emitting element LD may emit light depending on the amount of driving current flowing.

In the sub-pixel circuit SPC, capacitive coupling Cyk may occur between the data line DLj and an electrode of the first capacitor C1 (that is, the fourth node N4). In addition, capacitive coupling Cgk may occur between the data line DLj and another electrode of the first capacitor C1 (that is, the second node N2).

The capacitive couplings Cyk and Cgk (also referred to as parasitic capacitors) may affect the voltage stored in the first capacitor C1. As the voltage stored in the first capacitor C1 changes, the gate electrode N2 of the first transistor T1 may also be affected. These capacitive couplings and rapid changes in the data voltage supplied to the data line DLj may cause vertical crosstalk in which a line-like afterimage between adjacent vertical lines occurs.

FIG. 4 illustrates a block diagram of a compensation driver according to some embodiments of the present disclosure.

Referring to FIG. 4, the compensation driver 400 may include a compensation coefficient generation unit 410 and a compensation unit 420.

The controller 600 may output k-th raw data RD[k] of a grayscale domain to the compensation coefficient generation unit 410 and the compensation unit 420. The k-th raw data RD[k] may be a portion of the image data RGB of FIG. 1. The k-th raw data RD[k] may include raw data of some rows of the k-th frame and raw data of some rows of the (k+1)-th frame.

The compensation coefficient generation unit 410 may generate a compensation coefficient (that is, a k-th compensation coefficient CC[k]) to be applied to the raw data of a specific row of the (k+1)-th frame based on the k-th raw data RD[k]. The k-th compensation coefficient CC[k] may be a voltage value.

The compensation unit 420 may generate the k-th compensation data CD[k] of the grayscale domain by applying the compensation coefficient generated based on the (k−1)-th raw data to the raw data of a specific row of the k-th frame.

The (k−1)-th raw data may include raw data of some rows of the (k−1)-th frame and raw data of some rows of the k-th frame. The raw data of a specific row of the k-th frame may be included in the k-th raw data RD[k]. The k-th compensation data CD[k] may be a portion of the compensation data CRGB of FIG. 1. The k-th compensation data CD[k] may be data in which the crosstalk effect of the k-th raw data RD[k] is compensated. In other words, the compensation data CD[k] may be a modification of the raw data RD[k] which has been adjusted to account for the crosstalk effect.

The compensation unit 420 may output the k-th compensation data CD[k] to the data driver 500.

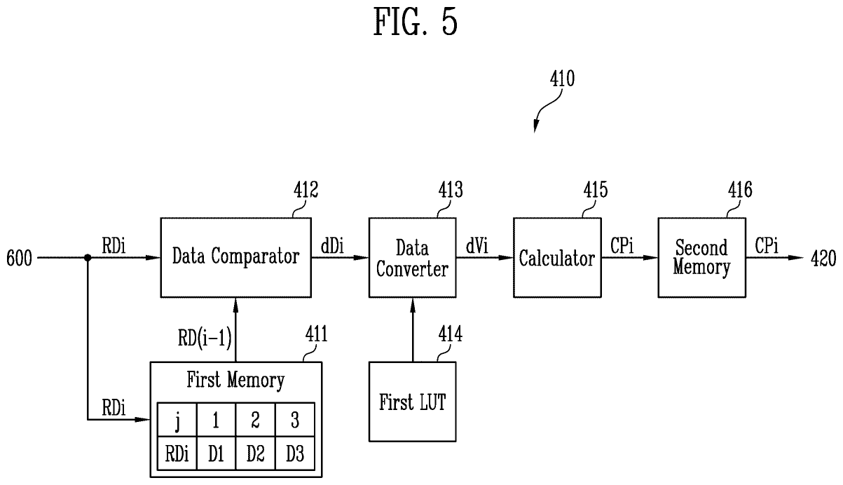

In FIG. 4, for better understanding and ease of description, the compensation coefficient generation unit 410 and the compensation unit 420 are described as operating in units of frames, but the compensation coefficient generation unit 410 may generate a compensation coefficient in units of rows and the compensation unit 420 may generate compensation data in units of rows. This will be described in more detail later with reference to FIG. 5 to FIG. 7.

FIG. 5 illustrates a block diagram of a compensation coefficient generation unit according to some embodiments of the present disclosure.

Referring to FIG. 5, the compensation coefficient generation unit 410 may include a first memory 411, a data comparator 412, a data converter 413, a first look-up table (LUT) 414, a calculator 415, and a second memory 416.

FIG. 5 will be described mainly with respect to the operation of the compensation coefficient generation unit 410 generating a compensation coefficient CPi based on raw data Rdi applied to pixels of the i-th pixel row of the k-th frame (hereinafter, raw data of the i-th pixel row). In addition, the compensation coefficient generation unit 410 may perform a crosstalk compensation operation on a still image.

The controller 600 may output the raw data RDi of the i-th pixel row to the first memory 411 and the data comparator 412. The raw data RDi of the i-th pixel row may be a portion of the image data RGB output from the controller 600.

The first memory 411 can store raw data in units of rows output from the controller 600. For example, when the display panel 100 of FIG. 1 includes three pixel columns, the first memory 411 may include first column data D1, second column data D2, and third column data D3 of the i-th pixel row.

In some embodiments, the first memory 411 may be a buffer memory. The first memory 411 may store the raw data RDi of the i-th pixel row and output the raw data RD(i−1) (hereinafter, raw data of the (i−1)-th row) applied to the pixels of the (i−1)-th row to the data comparator 412.

As the first memory 411 stores data in units of pixel rows rather than data of the entire frame, it may be implemented as a memory having a small capacity. Accordingly, the system cost of the compensation driver may be reduced.

The data comparator 412 may calculate the grayscale change of the raw data RD(i−1) of the (i−1)-th row and the raw data RDi of the i-th pixel row to generate an i-th change data dDi of the grayscale domain. That is, the data comparator 412 may generate the i-th change data dDi by subtracting the grayscale of the raw data RD(i−1) of the (i−1)-th row from the grayscale of the raw data RDi of the i-th pixel row.

For example, when the display panel 100 of FIG. 1 includes three pixel columns, the i-th change data dDi may include change data of the first, second, and third columns of the i-th pixel row.

The data comparator 412 may output the i-th change data dDi to the data converter 413.

The data converter 413 may convert the i-th change data dDi of the grayscale domain into the i-th voltage change amount dVi of the voltage domain. That is, the i-th voltage change amount dVi may be a voltage value corresponding to the i-th change data dDi.

For example, when the display panel 100 of FIG. 1 includes three pixel columns, the i-th voltage change amount dVi may include voltage change amounts of the first, second, and third columns of the i-th pixel row.

In some embodiments, the data converter 413 may convert the i-th change data dDi into the i-th voltage change amount dVi based on the first LUT 414. The first LUT 414 may store set voltage values (e.g., preset voltage values) corresponding to grayscales. The first LUT 414 may be configured as a separate block as shown in FIG. 5, or may exist in the form of data in a portion of another memory.

In some embodiments, by variously setting the frequency of the gate signals GL1 to GLm applied to the display panel 100 of FIG. 1, the luminance of the display panel 100, and the pattern displayed on the display panel 100, the correspondence relationship or function between the grayscales of image data RGB and the voltage values of the data signal generated by the data driver 500 may be calculated.

Through the calculated corresponding relationship or function, the data voltage values corresponding to the grayscales may be previously stored in the first LUT 414 (e.g., the data voltage values may be set or preset).

The calculator 415 may generate the compensation coefficient CPi of the i-th pixel row based on the i-th voltage change amount dVi and the accumulated voltage change amount.

The calculator 415 may generate the accumulated voltage change amount by accumulating and summing the i-th voltage change amount dVi received from the data converter 413. When the display panel includes x pixel rows, the accumulated voltage change amount may be a sum of x voltage change amounts (where x is a natural number greater than 1).

For example, before the i-th voltage change amount of the k-th frame is received from the data converter 413, the calculator 415 may accumulate the i-th voltage change amount of the (k−1)-th frame to the (i−1)-th voltage change amount of the k-th frame to store the summed accumulated voltage change amount.

Whenever the calculator 415 receives the i-th voltage change amount dVi from the data converter 413, the calculator 415 may generate the compensation coefficient CPi of the i-th pixel row. When the i-th voltage change amount of the k-th frame is received from the data converter 413, the calculator 415 may generate the compensation coefficient CPi of the i-th pixel row by subtracting the i-th voltage change amount dVi from the accumulated voltage change amount.

In the case of a still image, the i-th voltage change amount of the (k−1)-th frame may be the same as the i-th voltage change amount of the k-th frame. Accordingly, the compensation coefficient CPi of the i-th pixel row of the k-th frame can be the sum of the (i+1)-th voltage change amount of the (k−1)-th frame and the (i−1)-th voltage change amount of the k-th frame.

That is, when the display panel includes x pixel rows, the accumulated voltage change amount may include x voltage change amounts, and the compensation coefficient CPi of the i-th pixel row may include (x−1)-th voltage change amounts.

The calculator 415 may update the accumulated voltage change amount each time it generates the compensation coefficient CPi of the i-th pixel row. After generating the compensation coefficient CPi of the i-th pixel row of the k-th frame, the calculator 415 may update the accumulated voltage change amount to a value obtained by accumulating and adding the accumulated voltage change amount of the (i+1)-th voltage of the (k−1)-th frame to the i-th voltage change amount of the k-th frame.

In some embodiments, the calculator 415 may update the accumulated voltage change amount to a value obtained by adding the i-th voltage change amount of the k-th frame to the compensation coefficient CPi of the i-th pixel row of the k-th frame.

For example, when the display panel 100 of FIG. 1 includes three pixel columns, the accumulated voltage change amount may include the accumulated voltage change amounts of the first, second, and third columns of the i-th pixel row, and the compensation coefficient CPi of the i-th pixel row may include the compensation coefficients of the first, second, and third columns of the i-th pixel row.

Whenever data of one pixel row is input, the compensation coefficient generation unit 410 may generate change data and voltage change amount by comparing with data of a previous pixel row, update the accumulated voltage change amount of each of the pixels of the input pixel row, and may generate a compensation coefficient to be applied to each of the pixels of the input pixel row.

In addition, data of the (i−1)-th row of the k-th frame may be used for data compensation of the i-th pixel row of the k-th frame. Accordingly, the line crosstalk effect may be more accurately compensated (e.g., measured and adjusted for).

The calculator 415 may output the compensation coefficient CPi of the i-th pixel row to the second memory 416. In some embodiments, the second memory 416 may be a buffer memory. The second memory 416 may store the compensation coefficient CPi of the i-th pixel row.

The second memory 416 may output the compensation coefficient CPi of the i-th pixel row to the compensation unit 420.

As the first memory 411 and the second memory 416 store raw data and compensation coefficients in units of pixel rows rather than data of the entire frame, it may be implemented as a memory having a small capacity. Accordingly, the system cost of the compensation driver may be reduced.

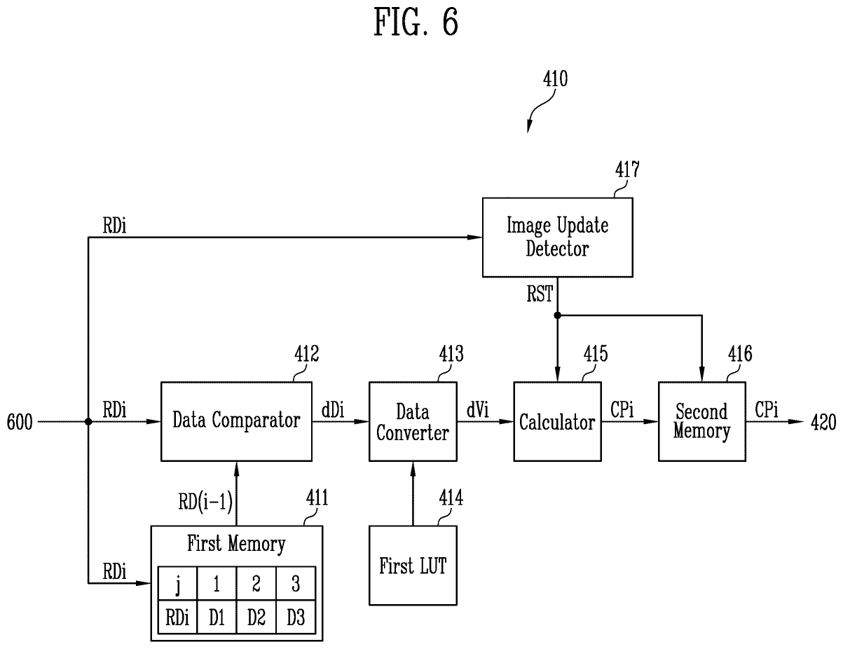

FIG. 6 illustrates a block diagram of a compensation coefficient generation unit according to some embodiments of the present disclosure.

Referring to FIG. 6, the compensation coefficient generation unit 410 may include a first memory 411, a data comparator 412, a data converter 413, a look-up table 414, a calculator 415, a second memory 416, and an image update detector 417.

FIG. 6 will be described mainly with respect to the operation of the compensation coefficient generation unit 410 generating a compensation coefficient CPi based on raw data RDi applied to pixels of the i-th pixel row of the k-th frame (hereinafter, raw data of the i-th pixel row).

In addition, the first memory 411, the data comparator 412, the data converter 413, the first look-up table (LUT) 414, the calculator 415, and the second memory 416 of FIG. 6 are similar to the first memory 411, the data comparator 412, the data converter 413, the first look-up table (LUT) 414, the calculator 415, and the second memory 416 of FIG. 5, and thus, redundant descriptions are omitted.

The controller 600 may output the raw data RDi of the i-th pixel row to the first memory 411, the data comparator 412, and the image update detector 417.

The image update detector 417 may compare the raw data RDi of the k-th to m-th pixel rows of the k-th frame with the raw data RDi of the first to m-th pixel rows of the (k−1)-th frame to determine whether the image of the k-th frame is different from the image of the (k−1)-th frame.

When the image of the k-th frame is different from the image of the (k−1)-th frame, the image update detector 417 may output a reset signal RST to the calculator 415 and the second memory 416. When the image of the k-th frame is the same as the image of the (k−1)-th frame, the image update detector 417 may not output the reset signal RST to the calculator 415 and the second memory 416.

The reset signal RST may initialize the accumulated voltage change amount stored in the calculator 415 and the compensation coefficient CPi of the i-th pixel row stored in the second memory 416. Accordingly, crosstalk compensation may be performed only in the case of a still image with high crosstalk visibility, and crosstalk compensation may not be performed in the case of a video with low crosstalk visibility. Thus, efficiency of the compensation coefficient generation unit 410 may be improved (e.g., increased).

In some embodiments, the image update detector 417 may include a checksum calculator.

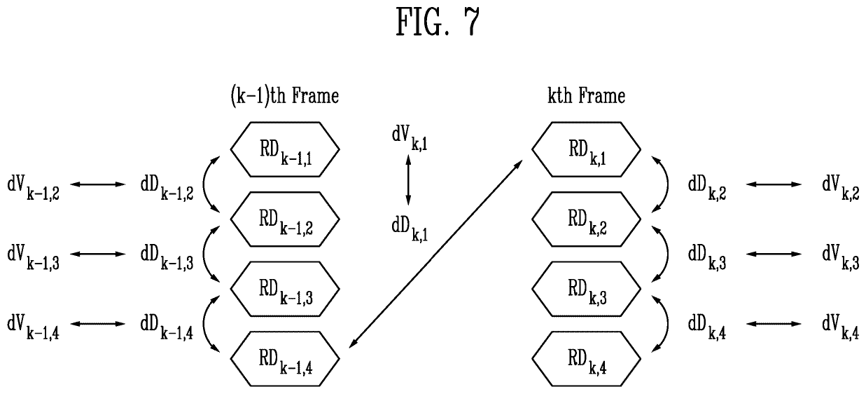

FIG. 7 is a drawing for explaining an operation of generating an accumulated voltage change amount and a compensation coefficient of a calculator according to some embodiments of the present disclosure.

Referring to FIG. 7, raw data RD_{k-1,1} to RD_{k-1,4} applied to the first to fourth pixel rows of the (k−1)-th frame and raw data RD_{k,1} to RD_{k,4} applied to the first to fourth pixel rows of the k-th frame are illustrated.

Referring to FIG. 6, when the images of the (k−1)-th frame and the k-th frame are the same, the image update detector 417 may not output the reset signal RST to the calculator 415 and the second memory 416. Accordingly, the calculator 415 and the second memory 416 may not be initialized.

The data comparator 412 may calculate the grayscale change of the raw data RD(i−1) of the (i−1)-th row and the raw data RDi of the i-th pixel row to generate the i-th change data dDi.

For example, the data comparator 412 may generate the third change data dD_{k-1,3} of the (k−1)-th frame by subtracting the grayscale of the raw data RD_{k-1,2} of the second row of the (k−1)-th frame from the grayscale of the raw data RD_{k-1,3} of the third row of the (k−1)-th frame.

In addition, the data comparator 412 may generate the first change data dD_{k,1} of the k-th frame by subtracting the grayscale of the raw data RD_{k,1} of the first row of the k-th frame from the grayscale of the raw data RD_{k-1,4} of the fourth row of the (k−1)-th frame.

Similarly, the data comparator 412 may generate second to fourth change data dD_{k-1,2} to dD_{k-1,4} of the (k−1)-th frame and first to fourth change data dD_{k,1} to dD_{k,4} of the k-th frame.

The data converter 413 may convert the i-th change data dDi into the i-th voltage change amount dVi. For example, the data converter 413 may convert the third change data dD_{k-1,3} of the (k−1)-th frame into the third voltage change amount dV_{k-1,3} of the (k−1)-th frame.

Similarly, the data converter 413 may generate second to fourth voltage change amounts dV_{k-1,2} to dV_{k-1,4} of the (k−1)-th frame and first to fourth voltage change amounts dV_{k,1} to dV_{k,4} of the k-th frame.

Each time a voltage change amount is received from the data converter 413, the calculator 415 may generate a compensation coefficient. The calculator 415 may update the accumulated voltage change amount each time the compensation coefficient is generated.

For example, between the time when the second voltage change amount dV_{k,2} of the k-th frame is received from the data converter 413 and the time when the third voltage change amount dV_{k,3} of the k-th frame is received from the data converter 413, the accumulated voltage change amount stored in the calculator 415 may be the sum of the third voltage change amount dV_{k-1,3} of the (k−1)-th frame, the fourth voltage change amount dV_{k-1,4} of the (k−1)-th frame, the first voltage change amount dV_{k,1} of the k-th frame, and the second voltage change amount dV_{k,2} of the k-th frame.

When the third voltage change amount dV_{k,3} of the k-th frame is received from the data converter 413, the calculator 415 may generate a compensation coefficient of the third pixel row of the k-h frame by subtracting the third voltage change amount dV_{k,3} of the k-h frame from the accumulated voltage change amount. Because it is a still image, the third voltage change amount dV_{k-1,3} of the (k−1)-th frame and the third voltage change amount dV_{k,3} of the k-th frame are the same. Therefore, the compensation coefficient of the third pixel row of the k-th frame may be the sum of the fourth voltage change amount dV_{k-1,4} of the (k−1)-th frame, the first voltage change amount dV_{k,1} of the k-th frame, and the second voltage change amount dV_{k,2} of the k-th frame.

After generating the compensation coefficient of the third pixel row of the k-th frame, the calculator 415 may update the accumulated voltage change amount. The updated accumulated voltage change amount may be the sum of the fourth voltage change amount dV_{k-1,4} of the (k−1)-th frame, the first voltage change amount dV_{k,1} of the k-th frame, the second voltage change amount dV_{k,2} of the k-th frame, and the third voltage change amount dV_{k,3} of the k-th frame.

The calculator 415 may update the accumulated voltage change amount by adding the third voltage change amount dV_{k,3} of the k-th frame to the compensation coefficient of the third pixel row of the k-th frame. Accordingly, between the time when the third voltage change amount dV_{k,3} of the k-th frame is received from the data converter 413 and the time when the fourth voltage change amount dV_{k,4} of the k-th frame is received from the data converter 413, the accumulated voltage change amount stored in the calculator 415 may be the sum of the fourth voltage change amount dV_{k-1,4} of the (k−1)-th frame, the first voltage change amount dV_{k,1} of the k-th frame, the second voltage change amount dV_{k,2} of the k-th frame, and the third voltage change amount dV_{k,3} of the k-th frame.

For better understanding and ease of description, FIG. 7 is mainly described with reference to a display panel including four pixel rows and one pixel column, but the present disclosure is not limited thereto, and may be applied to a display panel including a plurality of pixel rows and a plurality of pixel columns.

That is, the calculator 415 may generate the accumulated voltage change amount and compensation coefficient of each of a plurality of pixel columns

In other words, the compensation driver 400 of FIG. 1 may generate change data, voltage change amount, accumulated voltage change amount, compensation coefficient, and compensation data for each of a plurality of pixels.

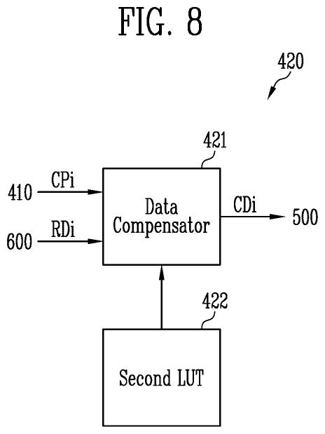

FIG. 8 illustrates a block diagram of a compensation unit according to some embodiments of the present disclosure.

Referring to FIG. 8, the compensation unit 420 may include a data compensator 421 and a second LUT 422.

The data compensator 421 may receive the raw data RDi of the i-th pixel row from the controller 600 and the compensation coefficient CPi of the i-th pixel row from the compensation coefficient generation unit 410.

The data compensator 421 may generate the compensation data CDi of the i-th pixel row by applying the compensation coefficient CPi of the i-th pixel row to the raw data RDi of the i-th pixel row.

For example, the data compensator 421 may generate the grayscale of the compensation data CDi of the i-th pixel row by adding the compensation coefficient CPi of the i-th pixel row to the grayscale of the raw data RDi of the i-th pixel row.

In some embodiments, the data compensator 421 may generate the compensation data CDi of the i-th pixel row in the raw data RDi of the i-th pixel row based on the compensation coefficient CPi of the i-th pixel row and a weight stored in the second LUT 422.

For example, the data compensator 421 may generate the grayscale of the compensation data CDi of the i-th pixel row by adding a value obtained by multiplying the compensation coefficient CPi of the i-th pixel row by a weight stored in the second LUT 422 to the grayscale of the raw data RDi of the i-th pixel row.

The second LUT 422 may store weights according to the temperature of the display device, the position of the i-th pixel row, and the frequency of the display panel. The second LUT 422 may be configured as a separate block as shown in FIG. 8, or may exist in the form of data in a portion of another memory.

In some embodiments, by variously setting the frequency of the gate signals GL1 to GLm applied to the display panel 100 of FIG. 1, the luminance of the display panel 100, and the pattern displayed on the display panel 100, a corresponding relationship or function between the temperature of the display device, the position of the i-th pixel row, and the frequency of the display panel and the grayscale of the image data RGB may be calculated.

Through the calculated corresponding relationship or function, the weight according to the temperature of the display device, the position of the i-th pixel row, and the frequency of the display panel may be previously stored in the second LUT 422.

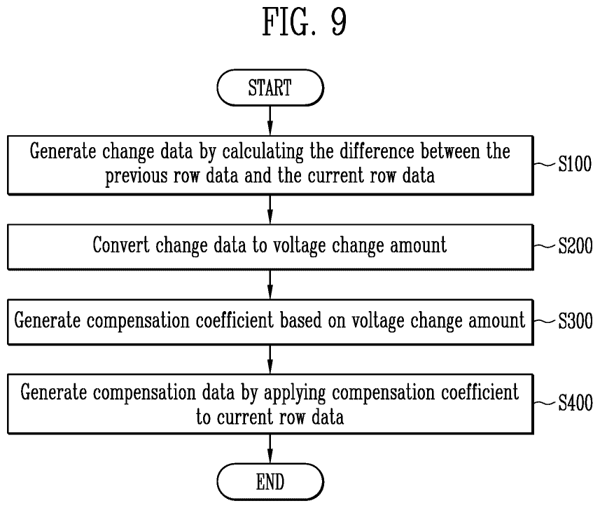

FIG. 9 illustrates a flowchart of an operation of the compensation driver of FIG. 1 according to some embodiments of the present disclosure.

Referring to FIG. 9, a compensation coefficient generation operation and a compensation data generation operation of the compensation driver 400 of FIG. 1 will be described.

In some embodiments, the compensation driver 400 may generate change data by calculating the difference between the previous row data and the current row data (S 100). The previous row data and the current row data may be raw data received from the controller 600. Referring to FIG. 5 and FIG. 6, the current row data may be the raw data RDi of the i-th pixel row, the previous row data may be the raw data RD(i−1) of the (i−1)-th pixel row, and the change data may be the i-th change data dDi.

Prior to generating the change data, the compensation driver 400 may receive the previous row data from the controller 600. After receiving the previous row data, the compensation driver 400 may receive the current row data from the controller 600.

The compensation driver 400 may convert the change data of the grayscale domain into the voltage change amount of the voltage domain (S 200).

Referring to FIG. 5 and FIG. 6, the compensation driver 400 may convert the i-th change data dDi into the i-th voltage change amount dVi based on the first LUT 414.

The compensation driver 400 may generate the compensation coefficient of the current row based on the voltage change amount (S 300).

In some embodiments, the compensation driver 400 may generate the compensation coefficient of the current row by subtracting the voltage change amount from the accumulated voltage change amount. When generating the compensation coefficient of the current row, the compensation driver 400 may update the accumulated voltage change amount to a value obtained by adding the voltage change amount to the compensation coefficient of the current row.

The accumulated voltage change amount may be a value that is accumulated and added from the current voltage change amount of the previous frame to the previous voltage change amount of the current frame.

The current voltage change amount of the previous frame may be a value obtained by converting the grayscale change of the data applied to the current pixel row in the previous frame and the data applied to the previous pixel row in the previous frame into the voltage domain.

The previous voltage change amount of the current frame may be a value obtained by converting the grayscale change of the data applied to the previous pixel row in the current frame and the data applied to the previous pixel row in the previous frame into the voltage domain.

Referring to FIG. 5 and FIG. 6, the compensation driver 400 may generate an accumulated voltage change amount by accumulating and adding the i-th voltage change amount dVi. The compensation driver 400 may generate the compensation coefficient CPi of the i-th pixel row by subtracting the i-th voltage change amount dVi from the accumulated voltage change amount.

The compensation driver 400 may generate compensation data by applying the compensation coefficient of the current row to the current row data. The compensation data of the grayscale domain may be output to the data driver 500 of FIG. 1.

Referring to FIG. 8, the compensation driver 400 may generate the compensation data CDi of the i-th pixel row by applying the compensation coefficient CPi of the i-th pixel row to the raw data RDi of the i-th pixel row.

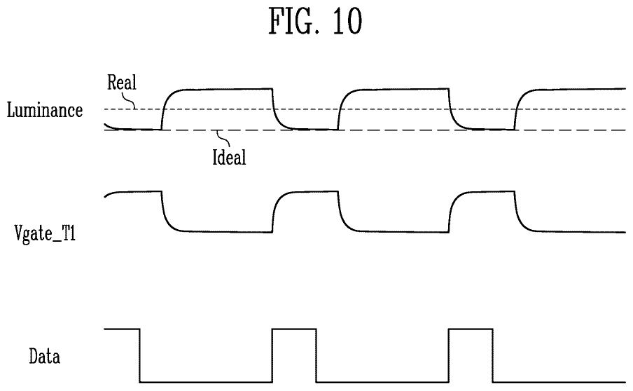

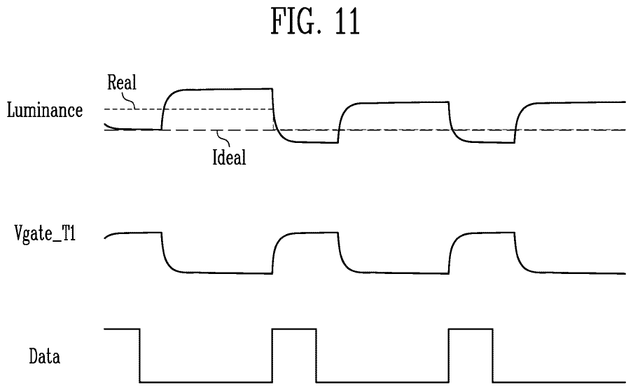

FIG. 10 is a drawing for explaining luminance of a display panel before crosstalk is compensated according to some embodiments of the present disclosure, and FIG. 11 is a drawing for explaining luminance of a display panel after crosstalk is compensated according to some embodiments of the present disclosure.

Referring to FIG. 10 and FIG. 11, the luminance of the display panel 100 of FIG. 1, the voltage applied to the gate electrode of the first transistor T1 of FIG. 3, and the data signal applied to the data line DLj are illustrated.

Referring to FIG. 10 and FIG. 11, the ideal average luminance of the display panel 100 is shown by a dashed line, the actual average luminance of the display panel 100 is shown by a dotted line, and the actual luminance of the display panel 100 is shown by a solid line.

Referring to FIG. 10, the actual average luminance may appear higher than the ideal average luminance due to vertical crosstalk.

Referring to FIG. 10 and FIG. 11, the voltage applied to the gate electrode of the first transistor T1 when compensation is performed may be lower than when compensation is not performed. That is, because the influence caused by a sudden change in the data voltage is compensated for through the compensation driver 400, the voltage applied to the gate electrode of the first transistor T1 may be lower than when compensation is not performed.

Accordingly, referring to the actual luminance of FIG. 11, the actual luminance may decrease after compensation is performed. In addition, the average luminance of FIG. 11 is initially higher than the ideal average luminance due to vertical crosstalk, but after compensation is performed, the actual average luminance may be the same as the ideal average luminance.

That is, the line-shaped afterimage between adjacent vertical lines may be improved due to abrupt changes in data voltage.

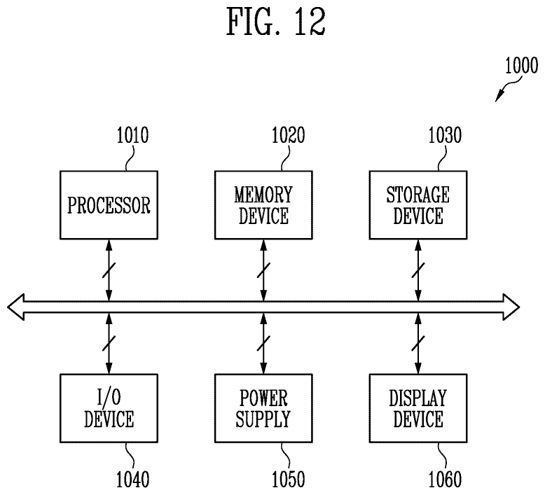

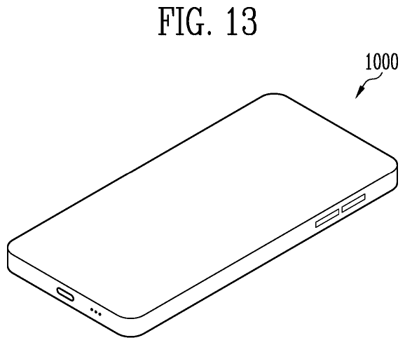

FIG. 12 illustrates a block diagram of an electronic device according to some embodiments of the present disclosure, and FIG. 13 illustrates an example in which the electronic device of FIG. 12 is implemented as a smart phone according to some embodiments of the present disclosure.

Referring to FIG. 12 and FIG. 13, an electronic device 1000 may include a processor 1010, a memory device 1020, a storage device 1030, an input/output device 1040, a power supply 1050, and a display device 1060. In some embodiments, the display device 1060 may be the display device of FIG. 1. In addition, the electronic device 1000 may further include several ports capable of communicating with a video card, a sound card, a memory card, a USB device, and the like, or communicating with other systems. In some embodiments, as shown in FIG. 13, the electronic device 1000 may be implemented as a smart phone. However, this is an example, and the electronic device 1000 is not limited thereto. For example, the electronic device 1000 may be implemented as a mobile phone, a video phone, a smart pad, a smart watch, a tablet PC, a vehicle navigation, a computer monitor, a laptop, a head mounted display device, or the like.

The processor 1010 may perform specific calculations or tasks. In some embodiments, the processor 1010 may be a microprocessor, a central processing unit, an application processor, or the like. The processor 1010 may be connected to other constituent elements through an address bus, a control bus, and a data bus. In some embodiments, the processor 1010 may also be connected to an extension bus, such as a peripheral component interconnect (PCI) bus.

The memory device 1020 may store data for operations of the electronic device 1000. For example, the memory device 1020 may include non-volatile memory devices, such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, and a ferroelectric random access memory (FRAM) device, and/or volatile memory devices, such as a dynamic random access memory (DRAM) device, a static random access memory (SRAM) device, and a mobile DRAM device.

The storage device 1030 may include a solid state drive (SSD), a hard disk drive (HDD), a CD-ROM, and the like.

The input/output device 1040 may include input devices, such as a keyboard, a keypad, a touch pad, a touchscreen, mouse, and the like, and output devices such as a speaker, a printer, and the like. In some embodiments, the display device 1060 may be included in the input/output device 1040.

The power supply 1050 may supply power for the operation of the electronic device 1000. For example, the power supply 1050 may be a power management integrated circuit (PMIC).

The display device 1060 may display an image corresponding to visual information of the electronic device 1000. For example, the display device 1060 may be an organic light emitting display device or a quantum dot light emitting display device, but is not limited thereto. The display device 1060 may be connected to other constituent elements through the buses or other communication links

It should be understood that embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and equivalents thereof.

What is claimed is:

1. A display device comprising:
a display panel comprising a plurality of pixel rows comprising a plurality of pixels;
a compensation driver configured to generate an i-th compensation coefficient based on a difference between an (i−1)-th image data provided to an (i−1)-th pixel row among the plurality of pixel rows and an i-th image data provided to an i-th pixel row among the plurality of pixel rows, and configured to generate an i-th compensation data provided to the i-th pixel row by applying the i-th compensation coefficient to the i-th image data; and
a data driver configured to generate a data signal based on the i-th compensation data and to supply the data signal to the i-th pixel row,
wherein i is a natural number greater than 1.

2. The display device of claim 1, wherein the compensation driver comprises:
a data comparator configured to calculate the difference between the (i−1)-th image data and the i-th image data to generate i-th change data;
a data converter configured to convert the i-th change data corresponding to grayscale change into an i-th voltage change amount; and
a calculator configured to generate the i-th compensation coefficient based on the i-th voltage change amount and an accumulated voltage change amount, and
wherein the accumulated voltage change amount is a value obtained by accumulating and adding the voltage change amount received from the data converter.

3. The display device of claim 2, wherein the display panel comprises x pixel rows, and the accumulated voltage change amount is a sum of x voltage change amounts, and wherein x is a natural number greater than 1.

4. The display device of claim 3, wherein the accumulated voltage change amount is a value obtained by accumulating and adding an i-th voltage change amount of a previous frame to an (i−1)-th voltage change amount of a current frame.

5. The display device of claim 4, wherein the calculator is configured to generate the i-th compensation coefficient by subtracting the i-th voltage change amount from the accumulated voltage change amount.

6. The display device of claim 5, wherein the i-th compensation coefficient comprises compensation coefficients applied to respective pixels of the i-th pixel row, and
wherein the accumulated voltage change amount is a sum of accumulated voltage change amounts of respective pixels of the i-th pixel row.

7. The display device of claim 5, wherein
the i-th compensation coefficient is a sum of x−1 voltage changes.

8. The display device of claim 7, wherein the i-th compensation coefficient is a value obtained by accumulating and adding an (i+1)-th voltage change amount of a previous frame to an (i−1)-th voltage change amount of a current frame.

9. The display device of claim 5, wherein the calculator is configured to generate the i-th compensation coefficient and to update the accumulated voltage change amount to a value obtained by adding the i-th voltage change amount to the i-th compensation coefficient.

10. The display device of claim 9, wherein the updated accumulated voltage change amount is a value obtained by accumulating and adding an (i+1)-th voltage change amount of a previous frame to an i-th voltage change amount of a current frame.

11. The display device of claim 9, wherein the compensation driver further comprises:
a first memory storing the (i−1)-th image data; and
a second memory storing the i-th compensation coefficient.

12. The display device of claim 11, wherein the compensation driver further comprises a first look-up table (LUT) configured to store voltage values corresponding to grayscales, and
wherein the data converter is configured to convert the i-th change data into an i-th voltage change amount based on the first look-up table.

13. The display device of claim 12, wherein the compensation driver further comprises an image update detector configured to compare the current frame and the previous frame, and to output a reset signal to the calculator and the second memory in response to the current frame and the previous frame being different, and
wherein the reset signal initializes the accumulated voltage change amount stored in the calculator and the i-th compensation coefficient stored in the second memory.

14. The display device of claim 13, wherein the image update detector is configured not to output a reset signal to the calculator and the second memory in response to the current frame and the previous frame being the same.

15. A driving method of a display device, comprising:
receiving current row data applied to a current pixel row comprising a plurality of pixels;
generating a voltage change amount based on a difference between a previous row data and the current row data;
generating a compensation coefficient corresponding to the current pixel row by subtracting the voltage change amount from an accumulated voltage change amount; and
generating compensation row data applied to the current pixel row by applying the compensation coefficient to the current row data.

16. The driving method of the display device of claim 15, wherein the generating of the voltage change amount based on the difference between the previous row data and the current row data comprises:
generating change data by calculating a grayscale change of the previous row data and the current row data; and
converting the change data in a grayscale domain into the voltage change amount in a voltage domain.

17. The driving method of the display device of claim 15, further comprising: updating the accumulated voltage change amount to a value obtained by adding the voltage change amount to the compensation coefficient, after generating the compensation coefficient.

18. The driving method of the display device of claim 17, wherein the accumulated voltage change amount is a value that is accumulated and added from a current voltage change amount of a previous frame to a previous voltage change amount of a current frame.

19. An electronic device comprising:
an input/output device configured to receive input data and provide output data;
a processor connected to the input/output device and configured to perform computations based on the input data; and
a display device configured to receive input data from the processor, the display device comprising:
a display panel comprising a plurality of pixel rows comprising a plurality of pixels;
a compensation driver configured to generate an i-th compensation coefficient based on a difference between an (i−1)-th image data provided to an (i−1)-th pixel row among the plurality of pixel rows and an i-th image data provided to an i-th pixel row among the plurality of pixel rows, and configured to generate an i-th compensation data provided to the i-th pixel row by applying the i-th compensation coefficient to the i-th image data; and
a data driver configured to generate a data signal based on the i-th compensation data and to supply the data signal to the i-th pixel row,
wherein i is a natural number greater than 1.

20. The electronic device of claim 19, wherein the electronic device is a smartphone.
